(19) United States
(12) Patent Application Publication
(10) Pub. No.: US 2012/0265163 A1
(43) Pub. Date: Oct. 18, 2012

(54) COUPLING SYSTEM TO TRANSFER MATERIAL BETWEEN CONTAINERS

(76) Inventors: Marc Bunjiun Cheng, Huntington Beach, CA (US); Albert Futsu Tien, Irvine, CA (US); Weibon Wayne Cheng, Walnut, CA (US)

(21) Appl. No.: 13/443,769

(22) Filed: Apr. 10, 2012

Related U.S. Application Data
(60) Provisional application No. 61/517,091, filed on Apr. 14, 2011.

(51) Int. Cl. A61J 1/20

(52) U.S. Cl. 604/415

(57) ABSTRACT

A container containing liquid medication which can be accessed with a needleless syringe is disclosed. The vial includes a stopper defining a central portion. A blind side of the central portion of the stopper has a plurality of flaps defined by grooves. These grooves define weakened or attenuated areas that rupture when a central tube of a male luer of the needleless syringe pushes into the stopper. A liquid tight seal is formed between the male luer of the needleless syringe and the stopper to prevent spillage of liquid medication during the extraction process.

### CROSS-REFERENCE TO RELATED APPLICATIONS

This application claims the benefits of U.S. Pat. App. Ser. No. 61/517,091, filed on Apr. 14, 2011, the entire contents of which are expressly incorporated herein by reference.

### STATEMENT RE: FEDERALLY SPONSORED RESEARCH/DEVELOPMENT

Not Applicable

### BACKGROUND

The embodiments disclosed herein relate to a needleless syringe having a standard male luer tip syringe that access liquid medication within a container without the associated dangers of needle pricking.

In the medical profession, liquid medication is administered to patients. Standard medical practice is to transfer the liquid medication from a vial into a syringe. The syringe is then used to inject the liquid medication into the patient. Unfortunately, the syringe has a sharp needle which is exposed while extracting fluid out of the vial. Also, the sharp needle of the syringe is exposed while administering the liquid medication to the patient. As a result, the medical professional may be pricked with the exposed needle. If the medical professional is pricked with the exposed needle prior to injecting the liquid medication into the patient, then the needle must be discarded, the liquid medication has been contaminated. Certain liquid medication is expensive. As such, discarding the liquid medication reduces the profitability of the medical center. Moreover, if the needle pricking occurs after injection of the liquid medication, then the blood born diseases of the patient can be transferred to the medical professional. These blood born diseases may include, but are not limited to HIV, hepatitis, etc.

Accordingly, there is a need in the art for an improved system and method for administering liquid medication to patient.

### BRIEF SUMMARY

The embodiments disclosed herein address the needs discussed above, discussed below and those that are known in the art.

A vial is disclosed herein which has a custom stopper that engages a standard male luer commonly used on a syringe. The stopper has a central portion defining an exposed surface and a blind surface. The blind surface has a plurality of grooves formed in a starburst pattern which define attenuated areas of the stopper. The grooves also define flaps which open outwardly in a starburst pattern upon engagement of the standard male luer to the stopper. The exposed side of the stopper has an optional cylindrical groove with mates with an outer hub of the male luer of the syringe to form a liquid tight seal therebetween. In use, the male luer is aligned to the stopper of the vial by aligning a central tube of the male luer to a central portion of the stopper. The central tube is then pushed into the stopper. The attenuated areas defined by the grooves on the blind side of the stopper rupture and the flaps extend downwardly and outwardly in a starburst pattern. At this point, the syringe has access to the liquid medication within the vial. A liquid tight seal is formed between the flaps and the central tube. Also, a liquid tight seal may be formed between the outer hub of the standard male luer and the cylindrical groove circumscribing the central portion of the stopper. The medical professional extracts the fluid from the vial into the syringe. After extraction, the syringe is removed from the vial. In doing so, the flaps quickly spring back to the closed position and prevent spillage of the liquid medication from the vial and also may prevent contamination of liquid medication within the vial. After transferring the liquid medication to the needleless syringe, the male luer is connected to an intravenous line connected to the patient. The entire process from extraction to administration is accomplished without a sharp needle. Hence, the medical professional is not exposed to contaminated needles. Moreover, the liquid medication in the vial remains sterile and can be accessed again until completely depleted.

More particularly, a medication vial for storing liquid medication to be used in conjunction with a needleless syringe to mitigate needle pricking is disclosed. The vial may comprise a container and a stopper. The container may define an open top. The stopper may be disposed in the open top to plug the open top so that the liquid medication remains in the container during storage. The stopper has a blind side with a plurality of preformed grooves that define attenuated areas of the stopper. The plurality of grooves intersect each other at a central area of the blind side of the stopper so as to define a plurality of flaps which spread open in a starburst pattern when the attenuated areas are ruptured.

The vial may also comprise a cover which may be disposed over the stopper to physically protect the attenuated areas of the stopper from being inadvertently ruptured and mitigate contamination of an exposed side of the stopper.

The container may have a flat bottom for standing the vial up during storage. The container also defines a longitudinal axis which is perpendicular to the flat bottom of the container and intersects a center of the open top. The intersection of the preformed grooves is aligned to the longitudinal axis. In other words, the longitudinal axis goes through the intersection of the preformed grooves.

The preformed grooves in the stopper may have a straight or curved configuration. These grooves may form flaps having the same shape and size. The flaps may flex downwardly upon connection with a needleless syringe within a perimeter of the open top. The stopper may be fabricated from a self-sealing elastomeric material or a self lubricating medical grade plastic.

The exposed side of the stopper may have an annular groove which receives an outer hub of a male luer of the needleless syringe. The annular groove may be sized to the outer hub to provide for a liquid tight seal therebetween. The outer hub of the male luer may have a friction fit with the annular groove so that the needleless syringe remains connected to the vial even when the vial is inverted and the syringe is released.

The exposed side of the stopper may have a central depressed area which receives a central tube of the male luer of the needleless syringe. The central depressed areas facilitates alignment of the male luer to the stopper. The depressed area may be sufficiently deep so as to define an inner surface frictionally engageable to an outer surface of the central nub so that the needleless syringe remains connected to the vial even when the vial is inverted and the syringe is released.

The flaps of the stopper may flex at bases. The flaps may engage a central tube of the needleless syringe to collectively provide a liquid tight seal with the central tube to prevent spillage of liquid medication in the vial and contamination of the liquid medication while extracting liquid from the vial.

The flaps may be fabricated from a resilient material to allow the flaps to quickly snap back to a closed configuration when the needleless syringe is removed from the stopper to mitigate spillage of liquid medication. More particularly, the stopper may be fabricated from a self closing material so that the liquid medication can be extracted from the vial with a needled syringe.

In another aspect, a method of extracting liquid medication from a vial is disclosed. The method may comprise the steps of providing a needleless syringe with a male luer, the male luer having a central tube and a outer hub; providing the vial; aligning the central tube of the needleless syringe to the central area of the stopper of the vial; pushing the central tube of the needleless syringe into the central area of the stopper; rupturing the central area of the stopper into a radial array of flaps during the pushing step to access liquid medication within the vial; forming a seal between the flaps and the central tube of the needleless syringe to mitigate spillage of liquid medication while extracting the liquid medication from the vial; inverting the vial and the needleless syringe so that the syringe is disposed at an elevation below the vial; retracting a plunger of the needleless syringe to transfer the liquid medication from the vial to the needleless syringe; inverting the vial and the needleless syringe so that the syringe is disposed at an elevation above the vial; removing the needleless syringe from the vial; and during the removing step, traversing the flaps back to a closed position to mitigate contamination of the liquid medication remaining in the vial and/or spillage of liquid medication from the vial.

The step of providing the vial may comprise a vial having a container and a stopper. The container may define an open top. Also, the stopper may be disposed in the open top to plug the open top so that the liquid medication remains in the container during storage. The stopper may have a blind side with a plurality of preformed grooves that define attenuated areas of the stopper. The plurality of grooves may intersect each other at a central area of the blind side of the stopper so as to define a plurality of flaps which spread open when the attenuated areas are ruptured.

The method may further comprise the steps of connecting the male luer of the needleless syringe to a mating component of a liquid medication line connected to a patient; and depressing the plunger of the needleless syringe.

In the method of extracting liquid medication from a vial, the same is accomplished without a sharp needle.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of an improved vial for accessing with a needleless syringe having a standard male luer;

FIG. 2 is an exploded top perspective view of the improved vial shown in FIG. 1;

FIG. 3 is a cross-sectional view of the improved vial shown in FIG. 1;

FIG. 4 is a bottom perspective view of a stopper shown in FIG. 2;

FIG. 5 is a cross-sectional exploded view of a stopper and a needleless syringe having a standard male luer;

FIG. 5A is a cross-sectional view of a needleless syringe engaged to a stopper illustrating flaps that form a liquid tight seal with a central tube of a standard male luer of the needleless syringe;

FIG. 6 is a bottom view of the stopper shown in FIG. 2;

FIG. 7 is a front cross-sectional view of a needleless syringe and the vial shown in FIG. 1 with the needleless syringe detached from the vial;

FIG. 8 is a cross-sectional view of the vial and the needleless syringe shown in FIG. 7 with a standard male luer of the needleless syringe aligned to a depression of a stopper of the vial;

FIG. 9 is a cross-sectional view of the vial and needleless syringe shown in FIG. 7 with the male luer of the needleless syringe engaged to the stopper of the vial;

FIG. 10 is a front cross-sectional view of a second embodiment of the stopper;

FIG. 11 is a front cross-sectional view of a needle-less syringe and a vial with the stopper shown in FIG. 10;

FIG. 12 illustrates a needleless syringe and a vial with the second embodiment of the stopper;

FIG. 13 illustrates the needleless syringe and vial shown in FIG. 12 with the male luer of the needleless syringe aligned to a depression of the stopper;

FIG. 14 illustrates the vial and needleless syringe shown in FIG. 12 with the male luer engaged to the second embodiment of the stopper;

FIG. 15 illustrates a needle syringe used to extract fluid from the vial having the first embodiment of the stopper;

FIG. 16 illustrates a needle syringe extracting fluid from a vial having the second embodiment of the stopper;

FIG. 17 is a bottom cross sectional view of the stopper illustrating flaps and grooves;

FIG. 18 is an illustration of the first embodiment of the stopper used in conjunction with a slip tip syringe;

FIG. 19 is an illustration of the second embodiment of the stopper used in conjunction with the slip tip syringe; and

FIG. 20 illustrates a schematic view of either the first or second embodiment of the stopper being used to extract or introduce fluid between two containers.

### DETAILED DESCRIPTION

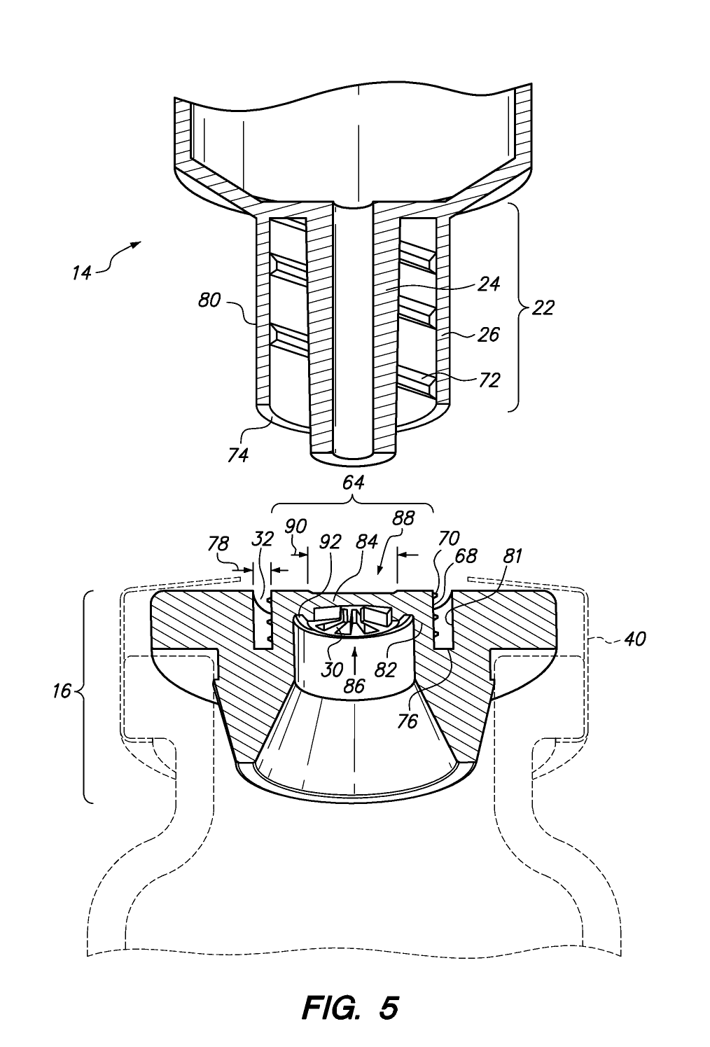

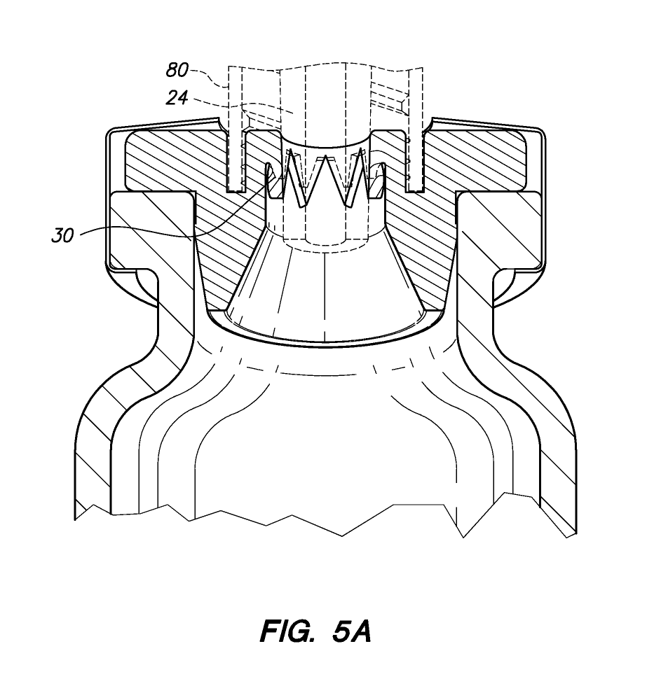

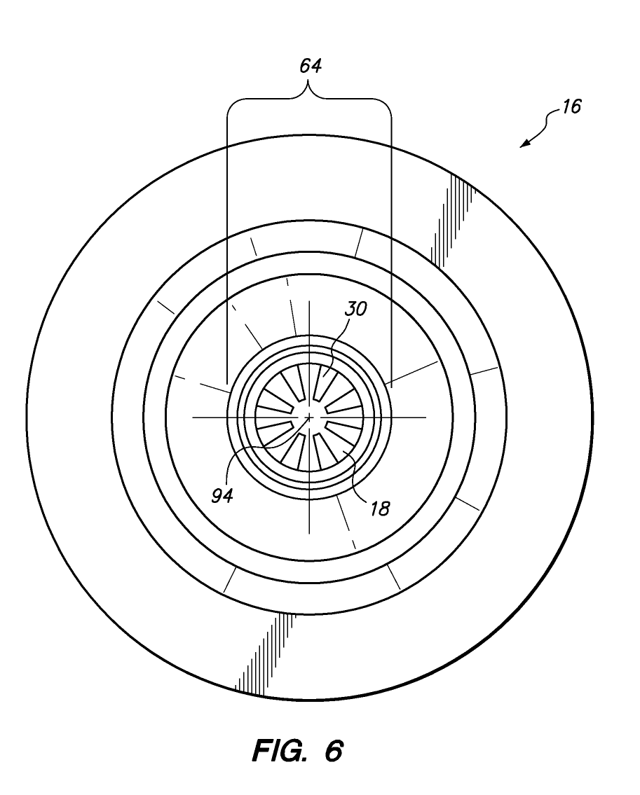

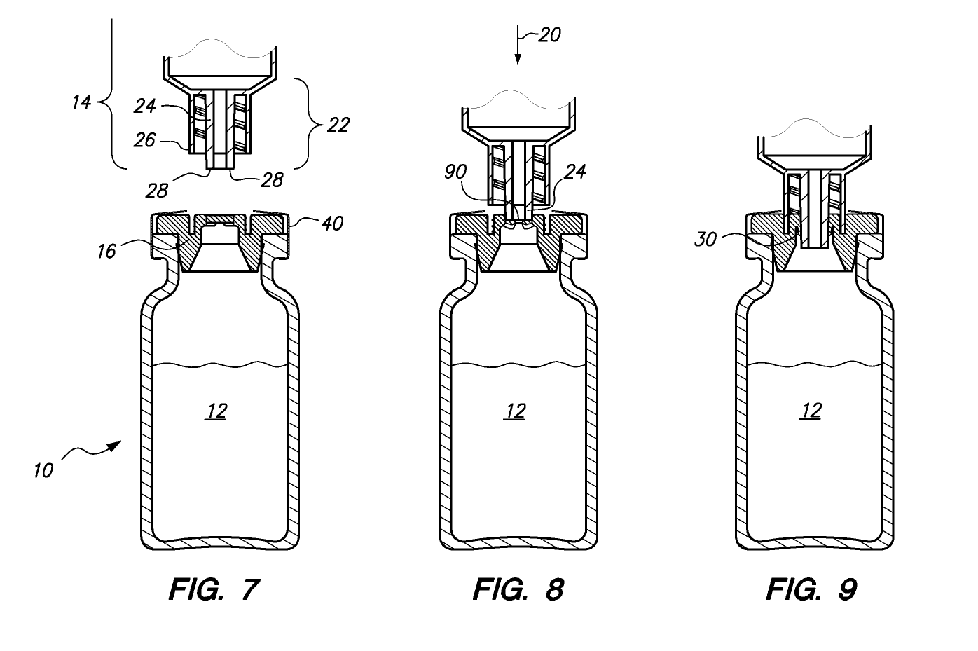

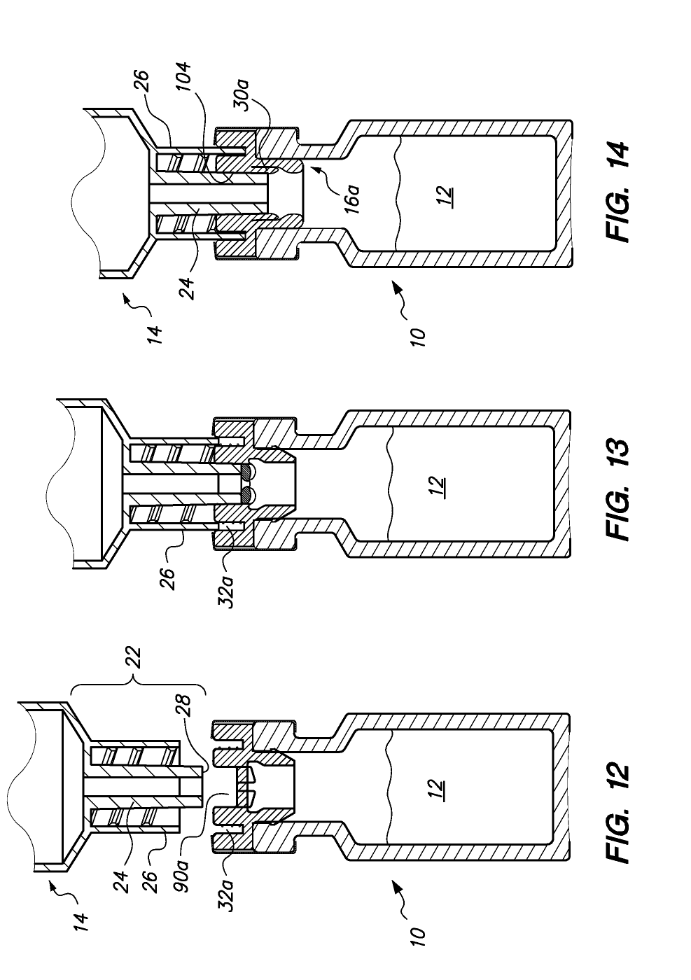

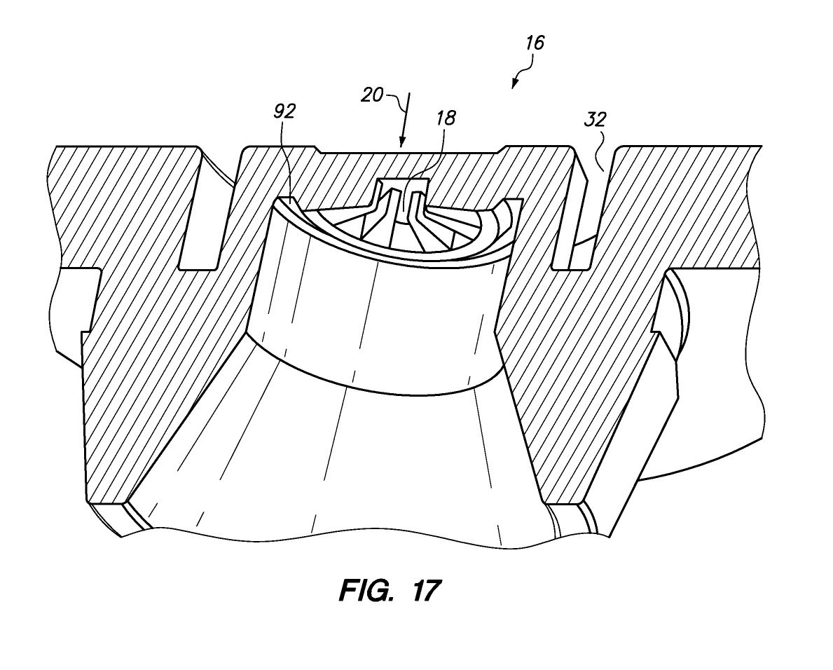

Referring now to the drawings, a vial 10 containing liquid medication 12 which may be extracted with a needleless syringe 14 (see FIG. 5) is shown. The vial 10 has a stopper 16 (see FIG. 2) with a plurality of grooves 18 (see FIG. 6) on the bottom side or blind side of the stopper 16. The grooves 18, provide attenuated areas which rupture with the application of force in the direction of arrow 20 (see FIG. 17) at the center of the stopper 16. The needleless syringe 14 has a male luer 22 (see FIG. 5). To extract fluid from the vial, the male lure 22 of the needleless syringe 14 has a central tube 24 and an outer hub 26. The central tube 24 is aligned to the center of the stopper 16, as shown in FIGS. 8 and 13. The distal end 28 (see FIGS. 7 and 12) of the central tube 24 applies pressure to the stopper 16 in the direction of arrow 20 which ruptures the stopper 16 at the attenuated areas defined by the grooves 18. The stopper 16 forms a plurality of flaps 30 which bend outwardly in a starburst pattern (see FIG. 5A) and form a seal against the central tube 24 of the male luer 22 to mitigate spillage of liquid medication 12 contained within the vial 10 when extracting the liquid medication from the vial 10. The syringe 14 is further inserted into the vial 10 as shown in FIGS. 9 and 14. In doing so, the outer hub 26 of the male luer 22 is received into a cylindrical groove 32 (see FIG. 5) formed in the exposed side of the stopper 16. The outer hub 26 and the cylindrical groove 32 provide a liquid tight seal. The flaps 30 and the central tube 24 provide another liquid tight seal. The vial 10 may be held upside down while the plunger of the needleless syringe 14 is retracted to transfer fluid from the vial 10 to the syringe 14. In the event that the syringe 14 is inadvertently released, (1) the friction between the flaps 30 and the central tube 24 and (2) the friction between the outer hub 26 and the surface of the cylindrical groove 32 prevent the syringe 14 from falling. Moreover, as shown in FIGS. 9 and 14, the distal end 28 of the central tube 24 does not deeply protrude into the vial 10 but is recessed in the stopper 16 so that most if not all of the liquid medication 12 may be extracted if necessary. It is also contemplated that the flaps 30 may resiliently expand back into the closed position upon removal of the syringe 14 from the vial 10 without spillage of liquid medication.

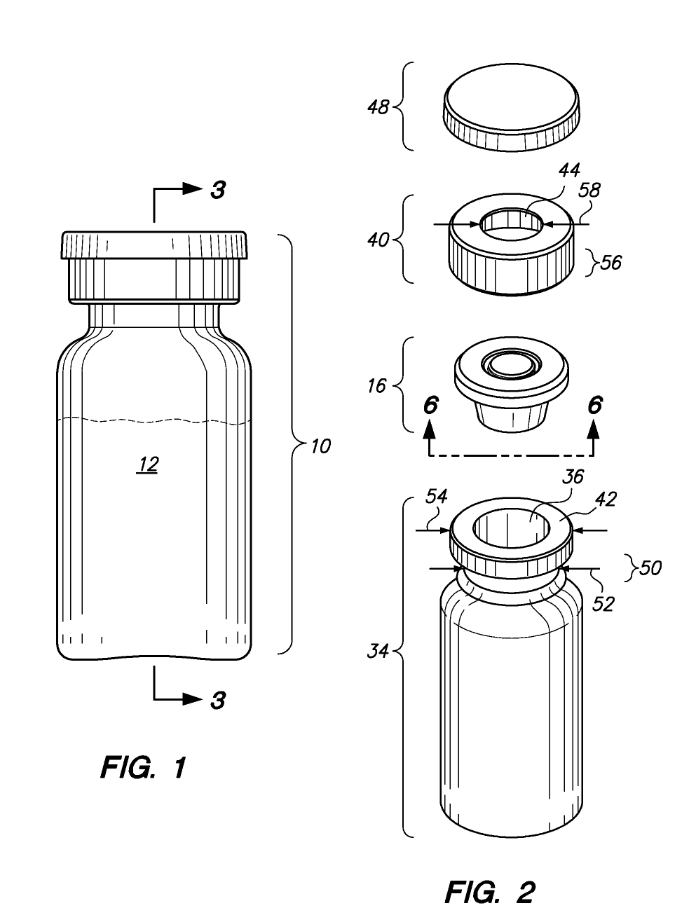

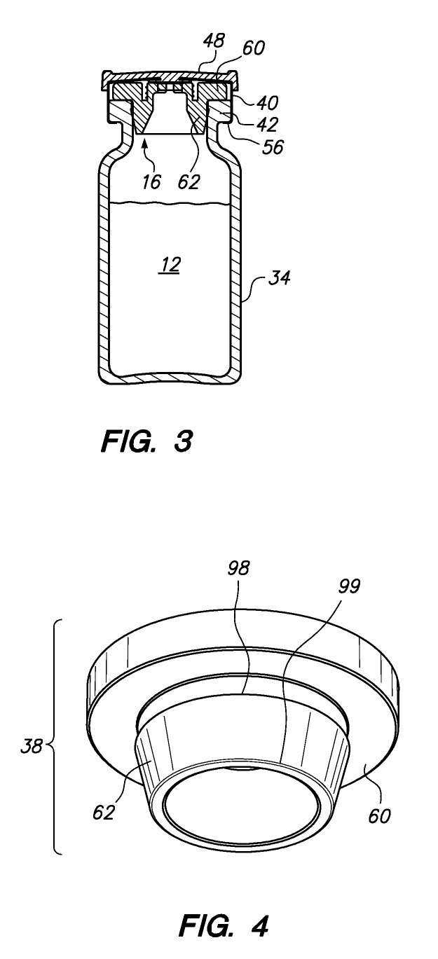

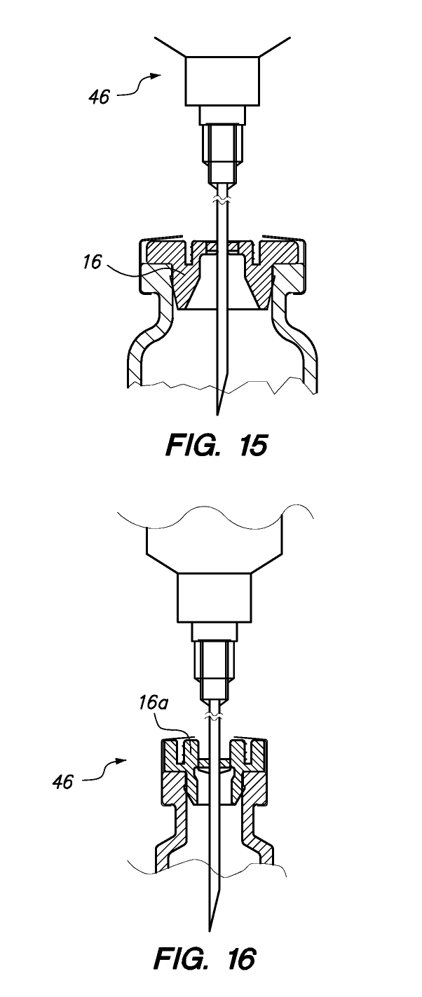

More particularly, referring now to FIG. 1, a medication vial 10 is shown. The medication vial 10 may contain liquid medication 12. As shown in FIG. 2, the medication vial 10 includes a container 34 that has an opening 36. The opening 36 receives a stopper 16 which serves as a plug to close the opening 36 and prevent escape of the liquid medication 12 contained within the liquid container 34 during storage. A retainer 40 is mounted over the stopper 16 and attached to a flange 42 (see FIG. 3) of the container 34 that defines the opening 36 of the container 34. The retainer 40 prevents the stopper 16 from being inadvertently dislodged from the opening 36 of the container 34 during storage and use. The retainer 40 has an opening 44 which is sufficiently large to allow access through the stopper 16 either with a needleless syringe 14 (see FIGS. 5 and 5A) or a needle syringe 46 (see FIGS. 15 and 16). A protective cap 48 is disposed on top of the retainer 40 to protect the exposed surface of the stopper 16 from contamination during storage.

Referring to FIG. 2, the container 34 may have a neck portion 50. The neck portion 50 has a diameter 52 which is smaller than a diameter 54 of the flange 42. The retainer 40 receives the flange 42 of the container 34 and the outer flange 60 of the stopper 16, as shown in FIG. 3. The bottom peripheral portion 56 of the retainer 40 is crimped under the flange 42 of the container 34 as shown in FIG. 3. The hole 44 of the retainer 40 has a diameter 58 which is smaller than the stopper 16 so that the stopper 16 cannot be dislodged from the container 34. When the retainer 40 is disposed on top of the stopper 16 and the flange 42, the retainer 40 holds the stopper 16 in place in the opening 36 of the container 34. The protective cap 48 may be placed over the retainer 40 and held in place by friction.

Referring now to FIGS. 3 and 4, the stopper 16 has an outer flange 60 that rests on top of the flange 42 of the container 34. A lower protrusion 62 of the stopper 16 extends into the opening 36 of the container 34 and forms a liquid tight seal against the inner surface of the container 34 as shown in FIG. 3. The lower protrusion 62 has a frusto conical surface to make insertion of the stopper 16 into the opening 36 of the container 34 easier. The frusto conical surface terminates at a lip 98 that has an outer diameter larger than the inner diameter of the opening 36 so that the lower protrusion 62 forms a liquid tight seal and no liquid escapes out of the container 34. Lower lip 99 has an outer diameter smaller than the inner diameter of the opening 36 for easy insertion of the stopper 16 into the container 34.

Referring now to FIG. 5, the stopper 16 may have a central portion 64. The central portion 64 is circumscribed by a cylindrical groove 32. The cylindrical groove 32 is optional but preferred when the syringe has a male luer. The cylindrical groove 32 and the central portion 64 are exposed through the opening 44 of the retainer 40 when the protective cap 48 is removed therefrom. The cylindrical groove 32 is sized and configured to snuggly receive the outer hub 26 of the male luer 22 of the needleless syringe 14 so that a liquid tight seal is formed therebetween. The outer surface 68 of the central portion 64 may have nubs 70 that circumscribe the central portion 64. When the outer hub 26 of the syringe 14 is received into the cylindrical groove 32, the nubs 70 form a seal against the interior surface of the outer hub 26. The nubs 70 and the outer surface 68 of the central portion 64 form a seal with the interior surface of the outer hub 26 to prevent liquid from spilling out of the vial 10 when extracting fluid 12 from the vial 10. Moreover, the nubs 70 are shown as being in a stacked pattern but may also collectively form a thread(s) that mates with the thread(s) 72 of the outer hub 26 of the male luer 22. Moreover, the distal end 74 of the outer hub 26 may also be pressed against the bottom surface 76 of the cylindrical groove 32 to provide a liquid tight seal therebetween. Moreover, the groove 32 may have a width 78 sized to provide a snug fit between the outer surface 80 of the outer hub 26 and the interior facing surface 81 of the groove 32 to further provide a liquid tight seal therebetween. The connection between the outer hub 26 of the male luer 22 and the cylindrical groove 32 promotes and mitigates spillage of liquid medication 12 while extracting liquid medication from the vial 10.

The central portion 64 of the stopper 16 may have a cylindrical wall 82. A top portion 84 of the central portion 64 defines a blind side 86 and an exposed side 88. The exposed side 88 may have a slight depression 90 which may be used to guide the central tube 24 of the male luer 22 to the proper location on the central portion 64. The blind side 86 may have recessed grooves 18 (see FIG. 17) that define flaps 30 which rotates down and out as the central tube 24 is forcibly pushed through the central portion 64 as shown in FIG. 5A. The flaps 30 may also form a seal with the central tube 24.

Referring now to FIG. 6, a plurality of flaps 30 may be formed in a radial array about a center 94 of the central portion 64. Grooves 18 between the flaps 30 define attenuated areas in the central portion 64. The grooves 18 may be straight, curved or triangular as shown in FIG. 6. The center 94 of the central portion 64 may also be attenuated so that the central tube 24 of the male luer 22 of the needleless syringe 14 can push through the central portion 64 and access the liquid medication 12 within the vial 10.

Referring now to FIGS. 7-9, during use, the protective cap 48 may be removed from the retainer 40. The exposed side of the stopper 16 is exposed through the opening 44 of the retainer 40. The medical professional may wipe down the exposed side with a disinfectant swab in preparing to extract liquid medication from the vial 10. After disinfecting the exposed surface of the stopper 16, the needleless syringe 14 which has a standard male lure 22 may be aligned to the central portion 64. As shown in FIG. 8, the central tube 24 is received in the depression 90 of the central portion 64. The medical professional exerts a force in the direction of arrow 20. The central portion 64 is ruptured and the flaps 30 extend downward in a starburst pattern. A recessed groove 92 (see FIG. 17) circumscribing the flaps 30 formed in the blind side 86 of the central portion 64 allow the flaps 30 to pivot outward in the starburst pattern.

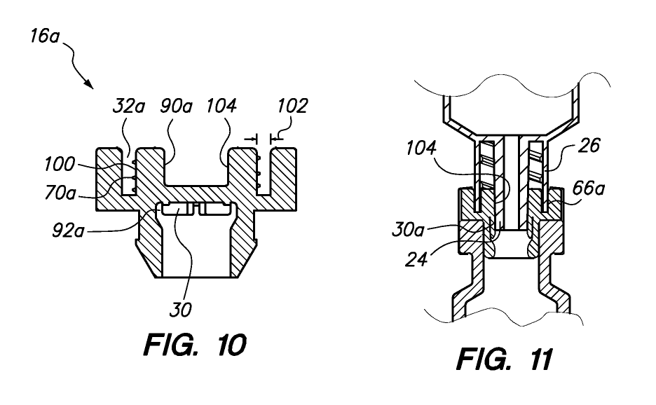

Referring now to FIG. 10, a second embodiment of the stopper 16a is shown. The second embodiment of the stopper 16a has the same configuration as that shown in FIGS. 1-9 except that the depression 90a is substantially deeper to provide a liquid tight seal against the central tube 24. Also, the recessed groove 92a has a pronounced undercut to further facilitate pivoting of the flaps 30.

The outer hub 26 of the male luer 22 is received into groove 32a. The exterior facing surface 100 of the central portion may have nub 70a formed in a stack pattern or as a thread that mates with the threads of the male luer 22. In either embodiment, a liquid tight seal is formed between the inner surface of the outer hub 26 and the exterior facing surface 100 of the groove 32a. Moreover, the groove 32a may have a width 102 which corresponds to the thickness of the outer hub 26 so that the outer hub 26 is snuggly received into the groove 32a and forms a liquid tight seal to prevent spillage of liquid during the extraction process.

As can be seen in FIG. 11, the outer hub 26 forms a liquid tight seal with the groove 32a. The flaps 30a forms a liquid tight seal with the central tube 24. Moreover, the central tube 24 also forms a liquid tight seal with the interior surface 104 of the depression 90a. Additionally, flaps 30a are pivoted into the recessed 92a to further facilitate pivoting movement of the flaps 30a during the extraction process.

Referring now to FIGS. 12-14, during use, the needleless syringe 14 may be aligned to the vial 10. In particular, the central tube 24 is aligned to the depression 90a. The central tube 24 is inserted into the depression 90a which also aligns the outer tube 26 to the cylindrical groove 32a. The central tube 24 is pushed through the stopper 16a. The flaps 30a are spread open to access the liquid medication 12. The outer hub 26 forms a liquid tight seal within the groove 32a. The central tube 24 forms a liquid tight seal with the interior surface 104 of the depression 90a and the flaps 30a. The vial 10 and the syringe 14 may be flipped upside down and the plunger of the syringe 14 may be retracted to transfer the fluid medication 12 from the vial 10 to the syringe 14.

Referring now to FIGS. 15 and 16, it is also contemplated that the stoppers 16 and 16a may be utilized with a needle syringe 46. The stoppers 16, 16a may be fabricated from a self closing elastic material such as any elastomeric material or butyl. After the needle of the syringe 46 is inserted through the stopper 16, 16a, the liquid medication is transferred into the syringe by retracting the plunger of the needled syringe 46. The needle is removed from the stopper 16, 16a. Upon removal, the elasticity of the stopper material closes up and prevents spillage of liquid medication from the vial.

When the needleless syringe 14 is engaged to the vial 10, a liquid tight seal may be formed between one or more of the following respective components or surfaces (1) the flaps 30, 30a and the central tube 24, (2) the central tube 24 and the interior surface 104 of the depression 90a, (3) the interior facing surface 81 of the cylindrical groove and the outer surface 80 of the outer hub 26, (4) the threads 72 or interior surface of the outer hub 26 and the outer surface 68, 100 of the cylindrical groove 32 and (5) the distal end 74 of the outer hub 26 and the bottom surface 76 of the cylindrical groove 32. The purpose of the liquid tight seal is to prevent spillage of the liquid medication and to prevent contamination of the liquid medication during the extraction process.

The flaps 30, 30a may be spread open when the male luer 22 of the needleless syringe 14 is attached to the vial 10. This allows liquid to be transferred from the vial 10 to the needleless syringe 14. Upon removal of the needleless syringe, the flaps 30, 30a may immediately spring back to the closed position to prevent or mitigate spillage of the liquid medication and to prevent contamination of the liquid medication. As such, if there is any remaining liquid medication with the vial 10, the medical professional can access the vial 10 again until the liquid medication is depleted.

Upon transfer of the liquid medication into the needleless syringe 14, the medical professional can then connect the male luer 22 of the needleless syringe 14 to a liquid medication line (e.g., intravenous line) set up on a patient by connecting the male luer 22 of the needleless syringe 14 to a mating luer on the liquid medication line. In this manner, a sharp needle is never used and the medical professional is not exposed to the dangers of accidental needle pricking.

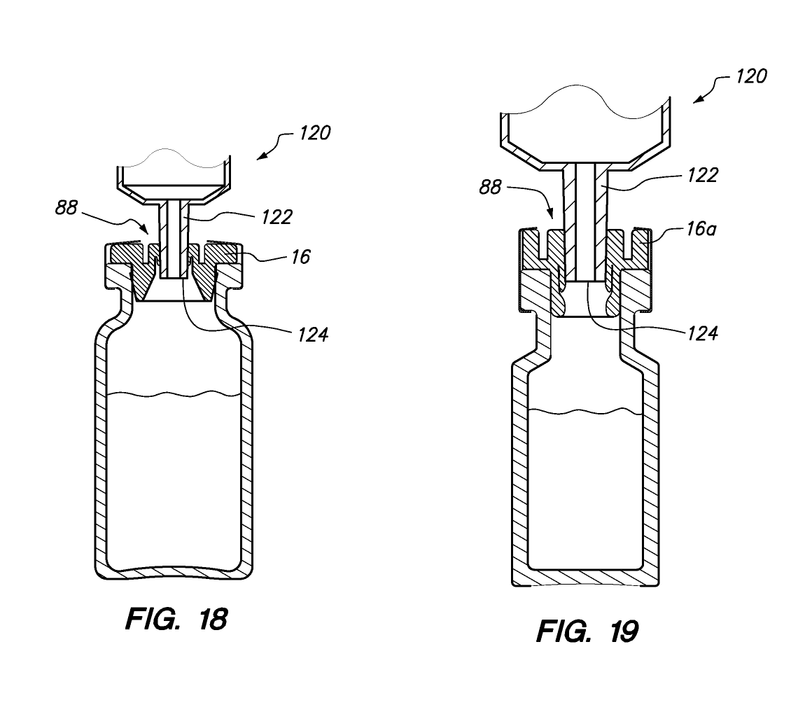

Referring now to FIGS. 18-19, instead of a standard needleless syringe with male luer as shown in relation to FIGS. 1-17, a slip tip syringe 120 can be engaged to the stopper 16, 16a and yet prevent spillage of medication and contamination of medication during the process of transferring the medication from the vial to the slip tip syringe and more generally from a first container to a second container. Moreover, although FIGS. 18-19 show application of the various aspects disclosed herein in relation to slip tip syringe 120, the various aspects disclosed herein may also be used in conjunction with a curved tipped syringe or a pipette which do not have an outer hub 26 as in the male luer 22.

In use, the elongate blunt tip portion 122 is pushed through the stopper 16 and ruptures stopper 16, 16a. The distal end 124 of the blunt tip portion 122 of the syringe 120 pushes against the exposed side 88 of the stopper 16, 16a. The attenuated areas or grooves 18 on the blind side of the stopper 16, 16a are ruptured through pressure created by the distal end 124 of the blunt elongate tip 122 of the syringe 120.

For the first embodiment of the stopper 16 shown in FIG. 18, the elongate blunt portion 122 of the slip tip syringe 120 forms a liquid tight seal with the flaps 30. The fluid from the vial can be transferred to the slip tip syringe 120 without spillage of liquid medication within the container. Upon pull out of the elongate blunt portion 122 of the slip tip syringe 120 from the stopper 16, the flaps 30 spring back to the closed position and prevent spillage and contamination of the liquid medication within the vial.

For the second embodiment of the stopper 16a shown in FIG. 19, the elongate blunt portion 122 of the slip tip syringe 120 forms a liquid tight seal with the flaps 30a. The fluid from the vial can be transferred to the slip tip syringe 120 without spillage of liquid medication within the container. Upon pull out of the elongate blunt portion 122 of the slip tip syringe 120 from the stopper 16a, the flaps 30a spring back to the closed position and prevent spillage and contamination of the liquid medication within the vial.

In both stoppers 16, 16a, the cylindrical groove 32, 32a are optional. As can be seen in FIGS. 18 and 19, the slip tip syringe 120 does not interact with the groove 32, 32a to form a liquid tight seal therebetween. Accordingly, it is contemplated that the stoppers 16, 16a may be fabricated without the cylindrical groove 32, 32a.

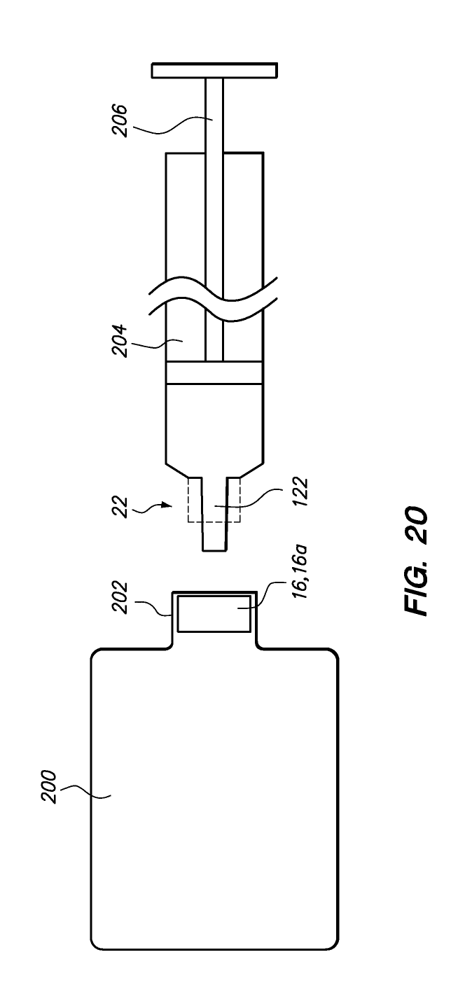

Referring now to FIG. 20, the stoppers 16, 16a either with or without the groove 32, 32a may be incorporated into an opening 202 of a container 200. The stopper 16, 16a may be attached to the opening 202 of the container 200 as discussed above with a retainer. However, it is also contemplated that the stopper 16, 16a may be attached to the opening through other means known in the art or developed in the future. The container 200 may be the vial 10 discussed above. However, the container 200 may be any type of liquid holding body. By way of example and not limitation, the container 200 may be a flexible bag, resilient bulb, bucket, or cup. The container 200 may have an opening 202 through which liquid may be extracted out of the container 200 to a second container 204 or introduced into the container 200 from the second container. The second container 204 may be needleless syringe with or without a male luer or a slip tip syringe as discussed above. However, the second container 204 may also be a curved tip syringe, pipette, or a resilient bulb.

In use, liquid may be contained within the container 200. To extract the liquid from the container 200, the male luer 22 or the elongate blunt tip portion 122 of the container 204 may be pushed through the stopper 16, 16a. This provides a temporary liquid tight seal so that the liquid in the container 200 can be extracted out and transferred to the container 204. To do so, the plunger 206 may be retracted to create a vacuum. Alternatively, a resilient bulb (i.e., second container 204) may be squeezed prior to engagement of the male luer 22 or the elongate blunt tip portion 122 and released after engagement. The resilient bulb expands and creates a vacuum to extract the fluid out of the container 200 into the container 204. It is also contemplated that liquid can be introduced into the container 200 from the container 204. To this end, the male luer 22 or the elongate blunt tip portion 122 engages the stopper 16, 16a as previously discussed. Liquid contained within container 204 can be introduced into the container 200 by creating pressure either by pushing the plunger 206 down or squeezing the resilient bulb (i.e., second container).

More generally, the stopper 16, 16a either with or without the cylindrical groove 32, 32a can be incorporated into a first conduit at one end thereof. A distal end of a second conduit may be fashioned to have the same configuration of the male luer or a blunt tip portion of a slip tip syringe. The first and second conduits may have liquid or gas flowing therethrough in a liquid tight manner through the various aspects discussed herein.

The above description is given by way of example, and not limitation. Given the above disclosure, one skilled in the art could devise variations that are within the scope and spirit of the invention disclosed herein, including various ways of securing the stopper 16, 16a to the container of the vial. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A medication storage system for storing liquid medication to be used in conjunction with a needleless syringe to mitigate needle pricking during fluid transfer, the system comprising:
a container defining an opening; and
a stopper disposed in the opening to plug the opening so that the liquid medication remains in the container during storage, the stopper having a blind side with a plurality of preformed grooves that define attenuated areas of the stopper, the plurality of grooves intersecting each other at a central area of the blind side of the stopper so as to define a plurality of flaps which spread open in a starburst pattern when the attenuated areas are ruptured.

2. The system of claim 1 further comprising a cover disposed over the stopper to physically protect the attenuated areas of the stopper from being inadvertently ruptured and mitigate contamination of an exposed side of the stopper.

3. The system of claim 1 wherein the container is a vial and defines a flat bottom for standing the vial up during storage, and the container defines a longitudinal axis which is perpendicular to the flat bottom of the container and intersects a center of the opening, wherein the intersection of the preformed grooves is aligned to the longitudinal axis.

4. The system of claim 1 wherein each of the preformed grooves is straight and the plurality of grooves form flaps having the same shape and size.

5. The system of claim 1 wherein each of the preformed grooves is curved and the plurality of grooves form flaps having the same shape and size.

6. The system of claim 4 wherein the flaps flex downwardly upon connection with a needleless syringe within a perimeter of the opening.

7. The system of claim 1 wherein the stopper is fabricated from a self-sealing elastic material or a self lubricating medical grade plastic.

8. The system of claim 1 wherein the exposed side of the stopper has an annular groove which receives an outer hub of a male luer of the needleless syringe, the annular groove being sized to the outer hub to provide for a liquid tight seal therebetween.

9. The system of claim 8 wherein the outer hub has a friction fit with the annular groove so that the needleless syringe remains connected to the vial even when the vial is inverted and the syringe is released.

10. The system of claim 8 wherein the exposed side of the stopper has a central depressed area which receives a central tube of the male luer of the needleless syringe to align the male luer to the stopper.

11. The system of claim 10 wherein the depressed area defines an inner surface frictionally engagable to an outer surface of the central nub so that the needleless syringe remains connected to the vial even when the vial is inverted and the syringe is released.

12. The system of claim 1 wherein the flaps flex at bases and the flaps engage a central tube of the needleless syringe to collectively provide a liquid tight seal with the central tube to prevent spillage of liquid medication in the vial and contamination of the liquid medication while extracting liquid from the vial.

13. The system of claim 1 wherein the flaps are fabricated from a resilient material to allow the flaps to quickly snap back to a closed configuration when the needleless syringe is removed from the stopper to mitigate spillage of liquid medication.

14. The system of claim 1 wherein the stopper is fabricated from a self closing material so that the liquid medication can be extracted from the vial with a needled syringe.

15. A method of extracting liquid medication from a container, the method comprising the steps of:
providing a needleless syringe with a male luer, the male luer having a central tube and an outer hub;
providing the container comprising:
a body defining an opening;
a stopper disposed in the opening to plug the opening so that the liquid medication remains in the body during storage, the stopper having a blind side with a plurality of preformed grooves that define attenuated areas of the stopper, the plurality of grooves intersecting each other at a central area of the blind side of the stopper so as to define a plurality of flaps which spread open when the attenuated areas are ruptured;
aligning the central tube of the needleless syringe to the central area of the stopper of the container;
pushing the central tube of the needleless syringe into the central area of the stopper;
rupturing the central area of the stopper into a radial array of flaps during the pushing step to access liquid medication within the container;
forming a seal between the flaps and the central tube of the needleless syringe to mitigate spillage of liquid medication while extracting the liquid medication from the container;
inverting the container and the needleless syringe so that the syringe is disposed at an elevation below the container;
retracting a plunger of the needleless syringe to transfer the liquid medication from the container to the needleless syringe;
inverting the container and the needleless syringe so that the syringe is disposed at an elevation above the container;
removing the needleless syringe from the container;
during the removing step, traversing the flaps back to a closed position to mitigate contamination of the liquid medication remaining in the container and/or spillage of liquid medication from the container.

16. The method of claim 15 further comprising the steps of:
connecting the male luer of the needleless syringe to a mating component of a liquid medication line connected to a patient;
depressing the plunger of the needleless syringe.

17. The method of claim 16 wherein the steps are accomplished without a sharp needle.
